(19) United States
(12) Patent Application Publication
(10) Pub. No.: US 2022/0332940 A1
(43) Pub. Date: Oct. 20, 2022

(54) POLYESTER COMPOSITION AND METHOD FOR PREPARING THE SAME, PRODUCT AND APPLICATION

(71) Applicant: CHANG CHUN PLASTICS CO., LTD., Taipei (TW)

(72) Inventors: Jie-Cheng Li, Taipei (TW); Te-Shun Lin, Taipei (TW); Hsin-Hsien Tsai, Taipei (TW)

(21) Appl. No.: 17/401,622

(22) Filed: Aug. 13, 2021

(30) Foreign Application Priority Data
Apr. 14, 2021 (CN) 202110402387.3
Apr. 14, 2021 (TW) 110113326

(51) Int. Cl. C08L 67/02; C08G 63/85; C08G 63/80; C08G 63/16

(52) U.S. Cl. CPC C08L 67/02; C08G 63/85; C08G 63/80; C08G 63/16

(57) ABSTRACT

The instant disclosure relates to a polyester composition and method for preparing the same, as well as products comprising the polyester composition and applications thereof. The polyester composition comprises aliphatic polyester, titanium and zirconium, wherein the weight ratio of titanium/zirconium is greater than 0.05. The polyester composition of the present invention has a specific titanium/zirconium weight ratio range, can reduce the process time, and can obtain a biodegradable composition with a lower acid value.

### BACKGROUND OF THE INVENTION

### 1. Technical Field

The present invention relates to a polyester composition and a preparation method of the polyester composition, as well as products containing the polyester composition and applications thereof, especially the polyester composition has a specific titanium/zirconium weight ratio.

### 2. Description of Related Art

Poly(butylene succinate) (PBS) is mainly obtained by the melt polymerization of succinic acid and butanediol. It can be decomposed into carbon dioxide and water by microorganisms in the soil, that is, it is biodegradable.

### BRIEF SUMMARY OF THE INVENTION

The inventor found that the polymerization of poly(butylene succinate) by using tetrabutyl titanate (TBT) alone as a catalyst cannot obtain a target viscosity and low acid value product in a short time.

In view of the fact that conventional polyester products cannot reach the expected viscosity and high acid value and the polymerization time is long, there is a continuous demand in the art for reducing the process time and obtaining a biodegradable composition with a lower acid value.

The present invention relates to a polyester composition comprising aliphatic polyester, titanium and zirconium, wherein the weight ratio of titanium/zirconium is greater than 0.05. In some preferred embodiments, the polyester composition is a biodegradable composition. In another aspect of the present invention, a method for preparing the aforementioned polyester composition is provided.

According to at least one embodiment, the aliphatic polyester is formed by esterification polymerization of C2-12 aliphatic dicarboxylic acid and C2-12 aliphatic diol.

According to at least one embodiment, the C2-12 aliphatic dicarboxylic acid is selected from a group consisting of malonic acid, oxalic acid, succinic acid, glutaric acid, 2-methylglutaric acid, 3-methylglutaric acid, adipic acid, pimelic acid, suberic acid, azelaic acid, sebacic acid, undecanedioic acid, dodecanedioic acid, brassylic acid, tetradecanedioic acid, 3,3-dimethylglutaric acid, fumaric acid, 2,2-dimethylglutaric acid, fatty acid dimer, 1,3-cyclopentane dicarboxylic acid, 1,4-cyclohexane dicarboxylic acid, 1,3-cyclohexane dicarboxylic acid, diglycolic acid, itaconic acid and maleic acid.

According to at least one embodiment, the C2-12 aliphatic diol is selected from a group consisting of ethylene glycol, 1,2-propanediol, 1,3-propanediol, 1,2-butanediol, 1,4-butanediol, 1,5-pentanedial, 1,6-hexanediol, 2,4-dimethyl-2-ethylthexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, cyclopentanediol, 1,4-cyclohexanediol, 1,2-cyclohexanedimethanol, 1,3-cyclohexanedimethanol, 1,4-cyclohexanedimethanol and 2,2 -tetramethyl-1,3-cyclobutanediol.

According to at least one embodiment, the content of the titanium is 15-130 ppm. In some preferred embodiments, the titanium is derived from a titanium-based compound, and the titanium-based compound is Ti(OR)₄, where R is a C1-C6 alkyl group.

According to at least one embodiment, the content of the zirconium is 2-250 ppm. In some preferred embodiments, the zirconium is derived from a zirconium-based compound, and the zirconium-based compound is selected from a group consisting of zirconium oxide, zirconium hydroxide, zirconium octoate, zirconium carbonate, alkaline earth zirconate, rare earth zirconate and zircon.

In addition, according to at least one embodiment, the polyester composition has an acid value of less than 20 meg KOH/g. In some cases, the polyester composition has a yellowness index (YI) of less than 55. In some preferred embodiments, the polyester composition has a yellowness index of less than 30. In some cases, the polyester composition has a melt index (MI) of about 1-30. In some preferred embodiments, the polyester composition has a melt index (MI) of 1-15.

According to at least one embodiment, the preparation method of the polyester composition comprises: (1) subjecting a C2-12 aliphatic dicarboxylic acid and a C2-12 aliphatic diol to an esterification reaction; and (2) using a zirconium-based compound and a titanium-based compound as a catalyst to perform a pre-polycondensation reaction to obtain the polyester composition; wherein the weight ratio of titanium/zirconium in the catalyst is greater than 0.05.

Additionally or alternatively, the present invention also relates to a product comprising the aforementioned polyester composition. On the other hand, the present invention provides an application of a polyester composition, which applies the aforementioned products to the packaging field, the disposable device field, the agricultural field and/or the medical field.

The inventor believes that by controlling the range of the weight ratio of titanium and zirconium in the polyester composition, for example, making the weight ratio of titanium/zirconium greater than 0.05, the process time of the polyester composition can be effectively reduced and a biodegradable composition with a lower acid value can be obtained.

### DETAILED DESCRIPTION OF THE INVENTION

The present invention provides a polyester composition, preferably a biodegradable composition. Specifically, the polyester composition includes aliphatic polyester, titanium and zirconium, wherein the weight ratio of titanium/zirconium is preferably greater than 0.05. In a preferred embodiment, the polyester composition includes aliphatic polyester, titanium and zirconium, wherein the weight ratio of titanium/zirconium is greater than 0.05, the content of titanium is 15-130 ppm, and the content of zirconium is 2-250 ppm. Additionally or alternatively, the present invention also provides a method for preparing the polyester composition. The aforementioned titanium/zirconium weight ratio is for example but not limited to: greater than 0.05, greater than 0.10, greater than 0.15, greater than 0.20, greater than 0.25, greater than 0.30, greater than 0.35, greater than 0.40, greater than 0.45, greater than 0.50, greater than 0.55, greater than 0.60, greater than 0.65, greater than 0.70, greater than 0.75, greater than 0.80, greater than 0.85, greater than 0.90, greater than 0.95, greater than 1, greater than 2, greater than 3, greater than 4, greater than 5, greater than 10, greater than 15, greater than 20, greater than 25, or greater than 30.

In some cases, the aliphatic polyester is formed by esterification polymerization of C2-12 aliphatic dicarboxylic acid and C2-12 aliphatic diol, wherein the C2-12 aliphatic dicarboxylic acid can be selected from a group consisting of malonic acid, oxalic acid, succinic acid, glutaric acid, 2-methylglutaric acid, 3-methylglutaric acid, adipic acid, pimelic acid, suberic acid, azelaic acid, sebacic acid, undecanedioic acid, dodecanedioic acid, brassylic acid, tetradecanedioic acid, 3,3-dimethylglutaric acid, fumaric acid, 2,2-dimethylglutaric acid, fatty acid dimer, 1,3-cyclopentane dicarboxylic acid, 1,4-cyclohexane dicarboxylic acid, 1,3-cyclohexane dicarboxylic acid, diglycolic acid, itaconic acid and maleic acid.

In some cases, the aliphatic polyester is formed by esterification polymerization of C2-12 aliphatic dicarboxylic acid and C2-12 aliphatic diol, wherein the C2-12 aliphatic diol can be selected from a group consisting of ethylene glycol, 1,2-propanediol, 1,3-propanediol, 1,2-butanediol, 1,4-butanediol, 1,5-pentanediol, 1,6-hexanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, cyclopentanediol, 1,4-cyclohexanediol, 1,2-cyclohexanedimethanol, 1,3-cyclohexanedimethanol, 1,4-cyclohexanedimethanol and 2,2,4,4-tetramethyl-1,3-cyclobutanediol.

In a preferred embodiment, the aliphatic polyester is formed by esterification polymerization of succinic acid and butylene glycol. In another preferred embodiment, the aliphatic polyester is formed by esterification polymerization of succinic acid, adipic acid and butylene glycol. In another preferred embodiment, the aliphatic polyester is formed by esterification polymerization of adipic acid and butylene glycol.

The “titanium (Ti)” referred to herein is based on the content of titanium atoms, which can be obtained, for example, by analyzing the content of titanium atoms with an inductively coupled plasma atomic emission spectrometer (ICP-AES). The titanium is derived from a titanium-based compound, and the titanium-based compound is Ti(OR)₄, where R is a C1-C6 alkyl group. In a preferred embodiment, the titanium-based compound is tetrabutyl titanate. The content of the titanium is preferably 15-130 ppm, such as but not limited to 15-130 ppm, 15-115 ppm, 15-100 ppm, 15-85 ppm, 15-70 ppm, 15-55 ppm, 15-40 ppm, 15-25 ppm, 20-130 ppm, 20-115 ppm, 20-100 ppm, 20-85 ppm, 20-70 ppm, 20-55 ppm, 20-40 ppm, 20-25 ppm, 30-130 ppm, 30-115 ppm, 30-100 ppm, 30-85 ppm, 30-70 ppm, 30-55 ppm, 40-130 ppm, 40-115 ppm, 40-100 ppm, 40-85 ppm, 40-70 ppm, 40-55 ppm, 50-130 ppm, 50-115 ppm, 50-100 ppm, 50-85 ppm, 50-70 ppm, 60-130 ppm, 60-115 ppm, 60-100 ppm, 60-85 ppm, 60-70 ppm, 70-130 ppm, 70-115 ppm, 70-100 ppm, 70-85 ppm, 80-130 ppm, 80-115 ppm, 80-100 ppm, 90-130 ppm, 90-115 ppm, 90-100 ppm, 100-130 ppm, or 100-115 ppm.

The “zirconium (Zr)” referred to herein is based on the content of zirconium atoms, which can be obtained, for example, by analyzing the content of zirconium atoms with an inductively coupled plasma atomic emission spectrometer. The zirconium is derived from a zirconium-based compound selected from a group consisting of zirconium oxide, zirconium hydroxide, zirconium octoate, zirconium carbonate, alkaline earth zirconate, rare earth zirconate and zircon. In some embodiments, the zirconium is derived from a zirconium-based compound selected from one of a group consisting of zirconium oxide, zirconium hydroxide, zirconium octoate, zirconium carbonate, alkaline earth zirconate, rare earth zirconate and zircon. In another embodiment, the zirconium is derived from a zirconium-based compound, and the zirconium-based compound is selected from two or more of the group consisting of zirconium oxide, zirconium hydroxide, zirconium octoate, zirconium carbonate, alkaline earth zirconate, rare earth zirconate and zircon. In a preferred embodiment, the zirconium-based compound is zirconium octoate. The content of the zirconium is preferably 2-250 ppm, such as but not limited to 2-250 ppm, 2-230 ppm, 2-210 ppm, 2-190 ppm, 2-170 ppm. 2-150 ppm, 2-130 ppm, 2-110 ppm, 2-90 ppm, 2-70 ppm, 2-50 ppm, 2-30 ppm, 2-10 ppm, 5-250 ppm, 5-230 ppm, 5-210 ppm. 5-190 ppm, 5-170 ppm, 5-150 ppm, 5-130 ppm, 5-110 ppm, 5-90 ppm, 5-70 ppm, 5-50 ppm, 5-30 ppm, 5-10 ppm, 10-250 ppm , 10-230 ppm, 10-210 ppm, 10-190 ppm, 10-170 ppm, 10-150 ppm, 10-130 ppm, 10-110 ppm, 10-90 ppm, 10-70 ppm, 10-50 ppm , 10-30 ppm, 30-250 ppm, 30-230 ppm, 30-210 ppm, 30-190 ppm, 30-170 ppm, 30-150 ppm, 30-130 ppm, 30-110 ppm, 30-90 ppm , 30-70 ppm, 30-50 ppm, 50-250 ppm, 50-230 ppm, 50-210 ppm, 50-190 ppm, 50-170 ppm, 50-150 ppm, 50-130 ppm, 50-110 ppm, 50-90 ppm. 50-70 ppm, 70-250 ppm, 70-230 ppm, 70-210 ppm, 70-190 ppm, 70-170 ppm, 70-150 ppm, 70-130 ppm, 70-110 ppm, 70-90 ppm, 90-250 ppm, 90-230 ppm, 90-210 ppm, 90-190 ppm, 90-170 ppm, 90-150 ppm, 90-130 ppm, 90-110 ppm, 110-250 ppm, 110-230 ppm, 110-210 ppm, 110-190 ppm, 110-170 ppm, 110-150 ppm, 110-130 ppm, 130-250 ppm, 130-230 ppm, 130-210 ppm, 130-190 ppm, 130-170 ppm, 130-150 ppm, 150-250 ppm, 150-230 ppm, 150-210 ppm, 150-190 ppm, 150-170 ppm, 170-250 ppm, 170-230 ppm, 170-210 ppm. 170-190 ppm. 190-250 ppm, 190-230 ppm, 190-210 ppm, 210-250 ppm, 210-230 ppm, or 230-250 ppm.

The polyester composition preferably has a relatively low acid value. The acid value of the polyester composition can be evaluated by an acid value test. In some cases, the aforementioned polyester composition has an acid value, which is preferably less than 20 meq KOH/g, for example, 19 meq KOH/g, 18 meq KOH/g, 17 meq KOH/g, 16 meq KOH/g, 15 meq KOH/g, 14 meq KOH/u, 13 meq KOH/g, 12 meq KOH/g, 11 meq KOH/g, 10 meq KOH/g, 9 meq KOH/g, 8 meq KOH/g, 7 meq KOH/g, 6 meq KOH/g, 5 meq KOH/g, 4 meq KOH/g, 3 meq KOH/g, 2 meq KOH/₁₋₄, or 1 meq KOH/g.

The polyester composition preferably has a relatively low yellowness index (YI). The yellowness index of the polyester composition can be evaluated by a color test. In some cases, the aforementioned polyester composition has a yellowness index, and the yellowness index is preferably less than 55, for example, it can be less than 55, less than 50, less than 45, less than 40, less than 35, less than 30, less than 25, less than 20, less than 15, less than 10, less than 5, or less than 3. In a preferred embodiment, the polyester composition has a yellowness index less than 30.

The polyester composition preferably has a desired viscosity. The viscosity of the polyester composition can be evaluated by a melt index (MI) test. Generally speaking, the larger the melt index, the better the fluidity; conversely, the smaller the melt index, the worse the fluidity. In some cases, the aforementioned polyester composition has a melt index, and the melt index is preferably about 1-30, for example, 1-30, 1-25, 1-20, 1-15, 1-10, 1-5, 2-30, 2-25, 2-20, 2-15, 2-10, 2-5, 3-30, 3-25, 3-20, 3-15, 3-10, 3-5, 4-30, 4-25, 4-20, 4-15, 4-10, 5-30, 5-25, 5-20, 5-15, 5-10, 10-30, 10-25, 10-20 or 10-15. In a preferred embodiment, the polyester composition has a melt index of 1-15.

In a preferred embodiment, the preparation method of the aforementioned polyester composition includes the following steps: (1) subjecting the C2-12 aliphatic dicarboxylic acid and the C2-12 aliphatic diol to an esterification reaction; and (2) using the zirconium-based compound and the titanium-based compound as a catalyst to perform a pre-polycondensation reaction to obtain the polyester composition; wherein the weight ratio of titanium/zirconium in the catalyst is greater than 0.05. Suitable methods and equipment for preparing the aforementioned polyester composition may include methods and equipment easily understood by those skilled in the art.

In another aspect, the present invention provides a polyester composition, the preparation method of which comprises the following steps: (1) subjecting the C2-12 aliphatic dicarboxylic acid and the C2-12 aliphatic diol to an esterification reaction; and (2) using the zirconium-based compound and the titanium-based compound as a catalyst to perform a pre-polycondensation reaction to obtain the polyester composition; wherein the weight ratio of titanium/zirconium in the polyester composition is greater than 0.05, the content of titanium is 15-130 ppm, and the content of zirconium is 2-250 ppm.

Additionally or alternatively, the preparation method of the polyester composition may further include the following step in some cases: (3) adding a chain extender to carry out a chain extension reaction. According to the method of the present invention, a predetermined degree of polymerization can be achieved without using a chain extender, but those skilled in the art can also use a chain extender as needed. The aforementioned chain extender may be a diisocyanate compound, a carbonate compound, or a dioxazoline compound, etc., and is preferably a diisocyanate compound.

The aforementioned diisocyanate compound is, for example, but not limited to, toluene 2,4-diisocyanate, toluene 2,6-diisocyanate, diphenylmethane 4,4′-diisocyanate, diphenylmethane 2,4′-diisocyanate, naphthalene 1,5-diisocyanate, xylene diisocyanate, hexamethylene diisocyanate, pentamethylene diisocyanate, isophorone diisocyanate, or diisocyanate of methylene bis(4-isocyanatocyclohexane). The diisocyanate compound is preferably hexamethylene diisocyanate.

The aforementioned carbonate compound is, for example, but not limited to, diphenyl carbonate, xylenyl carbonate, bis(chlorophenyl) carbonate, m-toluene carbonate, dinaphthyl carbonate, dimethyl carbonate, diethyl carbonate, dibutyl carbonate, ethylene carbonate, dipentyl carbonate, or dicyclohexyl carbonate. In addition, carbonate compounds derived from phenolic or alcoholic hydroxy compounds of the same type or different types of hydroxy compounds can also be used.

The aforementioned dioxazoline compound is, for example, but not limited to, 2,2′-bis(2-oxazoline), bis(2-oxazolinyl)methane, 1,2-bis(2-oxazolinyl)ethane, 1,3-bis(2-oxazolinyl)propane or 1,4-bis(2-oxazolinyl)butane, especially 1,4-bis(2-oxazolinyl)benzene, 1,2-bis(2-oxazolinyl)benzene or 1,3-bis(2-oxazolinyl)benzene. Other examples include 2,2′-bis(2-oxazoline), 2,2′-bis(4-methyl-2-oxazoline), 2,2′-bis(4,4′-dimethyl-2-oxazoline), 2,2′-bis(4-methyl-2-oxazoline), 2,2′-bis(4,4′-diethyl-2-oxazoline), 2,2′-bis(4-propyl-2-oxazoline), 2,2′-bis(4-butyl-2-oxazoline), 2,2′-bis(4-hexyl-2-oxazoline), 2,2′-bis(4-phenyl-2-oxazoline), 2,2′-bis(4-cyclohexyl-2-oxazoline), 2,2′-bis(4-benzyl-2-oxazoline), 2,2′-p-phenylene-bis(4-methyl-2-oxazoline), 2,2′-p-phenylene-bis(4,4′-dimethyl-2-oxazoline), 2,2′-m-phenylene-bis(4-methyl-2-oxazoline), 2,2′-m-phenylene-bis(4,4′-dimethyl-2-oxazoline), 2,2′-hexamethylene-bis(2-oxazoline), 2,2′-octamethylene-bis(2-oxazoline), 2,2′-decamethylene-bis(2-oxazoline), 2,2′-ethylene-bis(4-methyl-2-oxazoline), 2,2′-tetramethylene-bis(4,4′-dimethyl-2-oxazoline), 2,2′-9,9′-diphenoxyethane-bis(2-oxazoline), 2,2′-cyclohexylidene-bis(2-oxazoline) and 2,2′-diphenylene(2-oxazoline).

In another aspect, the present invention provides a product comprising the aforementioned polyester composition. In addition, the present invention also provides an application of the polyester composition, which applies the aforementioned products to the packaging field, the disposable device field, the agricultural field, and/or the medical field.

The aforementioned application refers to the application of products containing the polyester composition to basic materials in the packaging field (such as packaging films, bags, and boxes, cosmetic bottles, pharmaceutical bottles, and packaging of electronic devices), the disposable device field (such as disposable dining utensils or disposable medical supplies), the agricultural field (such as agricultural films or pesticide grade fertilizer slow release materials), and the medical field (such as biomedical polymer materials).

Although not limited by any particular theory, the inventor believes that as long as the pre-polycondensation reaction is controlled so that the titanium/zirconium weight ratio of the catalyst is within the desired range and/or the titanium/zirconium weight ratio in the resulting polyester composition is within the desired range, the process time can be reduced (such as <600 minutes), and the resulting polyester composition not only is a biodegradable composition, but also has a lower acid value and/or expected viscosity and/or lower yellowness index.

### Embodiment

The following non-limiting examples of aspects of the present invention are provided mainly to illustrate aspects of the invention and the benefits derived therefrom.

A non-limiting preparation method of the polyester composition is provided as follows. According to a method similar to the method disclosed below, 14 non-limiting example polyester compositions (Embodiments 1-14) and 3 comparative example polyester compositions (Comparative Examples 1-3) were prepared. However, the specific methods for preparing Embodiments 1-14 and Comparative Examples 1-3 were generally different from the methods disclosed below in one or more aspects.

### Polyester Preparation Process

Esterification: An aliphatic dicarboxylic acid (e.g., succinic acid) and an aliphatic diol (e.g., butanediol) are esterified at a temperature of 180-220° C. and a pressure of 50-100 kPa for 2-3 hours.

Pre-polycondensation: The resulting esterified product is transferred to a pre-polycondensation kettle and reacted for 4,5-6 hours at a temperature of 200-260° C. and a pressure of less than 0.1 kPa. During the pre-polycondensation reaction, an appropriate amount of catalyst is added for catalysis. The catalyst is a zirconium-based compound and a titanium-based compound.

Chain extension reaction (optional step): After the pre-polycondensation reaction, hexamethylene diisocyanate (HDI) is added to the obtained prepolymer at 180-220° C., stirred uniformly, and stayed for 0.5-1 hour.

Finished product collection: Finally, granulation is performed, and the melt index of the obtained aliphatic polyester (e.g., PBS) is about 1-30.

### Embodiment 1

Step (1): An aliphatic dicarboxylic acid (e.g., 50 parts by weight of succinic acid) and an aliphatic diol (e.g., 49.8 parts by weight of butanediol) were put into a reactor equipped with a stirring device, a nitrogen inlet, a heating device, a temperature detector, and a pressure reducing exhaust port for depressurization and deoxygenation, and the pressure was restored to atmospheric pressure with nitrogen. This step was repeated 3 times to fill the system with nitrogen.

Step (2): Next, the system was heated to 180-220° C. under nitrogen and 68 rpm stirring, and reacted at this temperature for 2 hours for dehydration.

Step (3): The esterified product of step (2) was transferred to a polycondensation kettle and reacted for 485 minutes at a temperature of 200-260° C. and a pressure of less than 0.1 kPa. As the viscosity of the reactant increased, the speed of the stirring device was reduced to 68 rpm, 52 rpm, and 32 rpm. During the polycondensation reaction, an appropriate amount of catalyst was added for catalysis. The catalyst was a zirconium-based compound (with a Zr atom content of 250 ppm) and a titanium-based compound (with a Ti atom content of 16.5 ppm).

Step (4): The polyester was drawn out in strip form from the bottom of the reactor at 200-260° C., immersed. in water at 10° C., and pelletized using a. pelletizing device to obtain the final pelletized polyester. The melt index of this polyester was about 1.19.

### Embodiment 2

Embodiment 2 was prepared using a process similar to that of Embodiment 1. However, in the step (3) of preparing Embodiment 2, the reaction temperature of the polycondensation kettle was 200-260° C., the reaction time was 330 minutes, and the pressure was less than 0.1 kPa. As the viscosity of the reactant increased, the speed of the stirring device was reduced to 68 rpm, 52 rpm, and 32 rpm. During the polycondensation reaction, an appropriate amount of catalyst was added for catalysis. The catalyst was a zirconium-based compound (with a Zr atom content of 225 ppm) and a titanium-based compound (with a Ti atom content of 40 ppm). The melt index of this polyester was about 1.75.

Embodiment 3

Embodiment 3 was prepared using a process similar to that of Embodiment 1. However, in the step (3) of preparing Embodiment 3, the reaction temperature of the polycondensation kettle was 200-260° C., the reaction time was 30.5 minutes, and the pressure was less than 0.1 kPa. As the viscosity of the reactant increased, the speed of the stirring device was reduced to 68 rpm, 52 rpm, and 32 rpm. During the polycondensation reaction, an appropriate amount of catalyst was added for catalysis, The catalyst was a zirconium-based compound (with a Zr atom content of 225 ppm) and a titanium-based compound (with a Ti atom content of 70 ppm), The melt index of this polyester was about 1.5.

### Embodiment 4

Embodiment 4 was prepared using a process similar to that of Embodiment 1. However, in the step (3) of preparing Embodiment 4, the reaction temperature of the polycondensation kettle was 200-260° C., the reaction time was 320 minutes, and the pressure was less than 0.1 kPa. As the viscosity of the reactant increased, the speed of the stirring device was reduced to 68 rpm, 52 rpm, and 32 rpm. During the polycondensation reaction, an appropriate amount of catalyst was added for catalysis. The catalyst was a zirconium-based compound (with a Zr atom content of 120 ppm) and a titanium-based compound (with a Ti atom content of 40 ppm). The melt index of this polyester was about 2.21.

### Embodiment 5

Embodiment 5 was prepared using a process similar to that of Embodiment 1. However, in the step (3) of preparing Embodiment 5, the reaction temperature of the polycondensation kettle was 200-260° C., the reaction time was 300 minutes, and the pressure was less than 0.1 kPa. As the viscosity of the reactant increased, the speed of the stirring device was reduced to 68 rpm, 52 rpm, and 32 rpm. During the polycondensation reaction, an appropriate amount of catalyst was added for catalysis. The catalyst was a zirconium-based compound (with a Zr atom content of 120 ppm) and a titanium-based compound (with a Ti atom content of 70 ppm). The melt index of this polyester was about 3.1.

### Embodiment 6

Embodiment 6 was prepared using a process similar to that of Embodiment 1. However, in the step (3) of preparing Embodiment 6, the reaction temperature of the polycondensation kettle was 200-260° C., the reaction time was 480 minutes, and the pressure was less than 0.1 kPa. As the viscosity of the reactant increased, the speed of the stirring device was reduced to 68 rpm. 52 rpm, and 32 rpm. During the polycondensation reaction, an appropriate amount of catalyst was added for catalysis. The catalyst was a zirconium-based compound (with a Zr atom content of 120 ppm) and a titanium-based compound (with a Ti atom content of 25 ppm). The melt index of this polyester was about 1.5.

### Embodiment 7

Embodiment 7 was prepared using a process similar to that of Embodiment 1. However, in the step (3) of preparing Embodiment 7, the reaction temperature of the polycondensation kettle was 200-260° C., the reaction time was 540 minutes, and the pressure was less than 0.1 kPa. As the viscosity of the reactant increased, the speed of the stirring device was reduced to 68 rpm, 52 rpm. and 32 rpm. During the polycondensation reaction, an appropriate amount of catalyst was added for catalysis. The catalyst was a zirconium-based compound (with a Zr atom content of 50 ppm) and a titanium-based compound (with a Ti atom content of 25 ppm). The melt index of this polyester was about 4.54.

### Embodiment 8

Embodiment 8 was prepared using a process similar to that of Embodiment 1. However, in the step (3) of preparing Embodiment 8, the reaction temperature of the polycondensation kettle was 200-260° C., the reaction time was 305 minutes, and the pressure was less than 0.1 kPa. As the viscosity of the reactant increased, the speed of the stirring device was reduced to 68 rpm, 52 rpm, and 32 rpm. During the polycondensation reaction, an appropriate amount of catalyst was added for catalysis. The catalyst was a zirconium-based compound (with a Zr atom content 100 ppm) and a titanium-based compound (with a Ti atom content of 100 ppm). The melt index of this polyester was about 2.87.

### Embodiment 9

Embodiment 9 was prepared using a process similar to that of Embodiment 1. However, in the step (3) of preparing Embodiment 9, the reaction temperature of the polycondensation kettle was 200-260° C. the reaction time was 320 minutes, and the pressure was less than 0.1 kPa. As the viscosity of the reactant increased, the speed of the stirring device was reduced to 68 rpm, 52 rpm, and 32 rpm. During the polycondensation reaction, an appropriate amount of catalyst was added for catalysis. The catalyst was a zirconium-based compound (with a Zr atom content of 50 ppm) and a titanium-based compound (with a Ti atom content of 100 ppm). The melt index of this polyester was about 4.82.

### Embodiment 10

Embodiment 10 was prepared using a process similar to that of Embodiment 1. However, in the step (3) of preparing Embodiment 10, the reaction temperature of the polycondensation kettle was 200-260° C., the reaction time was 365 minutes, and the pressure was less than 0.1 kPa. As the viscosity of the reactant increased, the speed of the stirring device was reduced to 68 rpm, 52 rpm, and 32 rpm. During the polycondensation reaction, an appropriate amount of catalyst was added for catalysis. The catalyst was a zirconium-based compound (with a Zr atom content of 20 ppm) and a titanium-based compound (with a Ti atom content of 100 ppm). The melt index of this polyester was about 3.59.

### Embodiment 11

Embodiment 11 was prepared using a process similar to that of Embodiment 1. However, in the step (3) of preparing Embodiment 11, the reaction temperature of the polycondensation kettle was 200-260° C., the reaction time was 470 minutes, and the pressure was less than 0.1 kPa. As the viscosity of the reactant increased, the speed of the stirring device was reduced to 68 rpm, 52 rpm, and 32 rpm. During the polycondensation reaction, an appropriate amount of catalyst was added for catalysis. The catalyst was a zirconium-based compound (with a Zr atom content of 10 ppm) and a titanium-based compound (with a Ti atom content of 100 ppm). The melt index of this polyester was about 4.31.

### Embodiment 12

Embodiment 12 was prepared using a process similar to that of Embodiment 1. However, in the step (3) of preparing Embodiment 12, the reaction temperature of the polycondensation kettle was 200-260° C., the reaction time was 345 minutes, and the pressure was less than 0.1 kPa. As the viscosity of the reactant increased, the speed of the stirring device was reduced to 68 rpm, 52 rpm, and 32 rpm. During the polycondensation reaction, an. appropriate amount of catalyst was added for catalysis. The catalyst was a zirconium-based compound (with a Zr atom content of 5 ppm) and a titanium-based compound (with a Ti atom content of 125 ppm). The melt index of this polyester was about 4.85.

### Embodiment 13

Embodiment 13 was prepared using a process similar to that of Embodiment 1. However, in the step (3) of preparing Embodiment 13, the reaction temperature of the polycondensation kettle was 200-260° C., the reaction time was 315 minutes, and the pressure was less than 0.1 kPa. As the viscosity of the reactant increased, the speed of the stirring device was reduced to 68 rpm, 52 rpm, and 32 rpm. During the polycondensation reaction, an appropriate amount of catalyst was added for catalysis. The catalyst was a zirconium-based compound (with a Zr atom content of 2 ppm) and a titanium-based compound (with a Ti atom content of 90 ppm). The melt index of this polyester was about 4.39.

### Embodiment 14

Step (1): An aliphatic dicarboxylic acid (e.g., 55.36 parts by weight of adipic acid) and an aliphatic diol (e.g., 44.37 parts by weight of butanediol) were put into a reactor equipped with a stirring device, a nitrogen inlet, a heating device, a temperature detector, and a pressure reducing exhaust port for depressurization and deoxygenation, and the pressure was restored to atmospheric pressure with nitrogen. This step was repeated 3 times to fill the system with nitrogen.

Step (2): Next, the system was heated to 180-220° C. under nitrogen and 68 rpm stirring, and reacted at this temperature for 2 hours for dehydration.

Step (3): The esterified product of step (2) was transferred to a polycondensation kettle and reacted for 475 minutes at a temperature of 200-260° C. and a pressure of less than 0.1 kPa, As the viscosity of the reactant increased, the speed of the stirring device was reduced to 68 rpm, 52 rpm, and 32 rpm. During the polycondensation reaction, an appropriate amount of catalyst was added for catalysis. The catalyst was a zirconium-based compound (with a Zr atom content of 100 ppm) and a titanium-based compound (with a Ti atom content of 100 ppm).

Step (4): The polyester was drawn out in strip form from the bottom of the reactor at 200-260° C., immersed in water at 10° C., and pelletized using a pelletizing device to obtain the final pelletized polyester. The melt index of this polyester was about 14.2.

### Comparative Example 1

Step (1): An aliphatic dicarboxylic acid (e.g., 50 parts by weight of succinic acid) and an aliphatic diol (e.g., 49.8 parts by weight of butanediol) were put into a reactor equipped with a stirring device, a nitrogen inlet, a heating device, a temperature detector, and a pressure reducing exhaust port for depressurization and deoxygenation, and the pressure was restored to atmospheric pressure with nitrogen. This step was repeated 3 times to fill the system with nitrogen.

Step (2): Next, the system was heated to 180-220° C. under nitrogen and 68 rpm stirring, and reacted at this temperature for 2 hours for dehydration.

Step (3): The esterified product of step (2) was transferred to a polycondensation kettle and reacted for 540 minutes at a temperature of 200-260° C. and a pressure of less than 0.1 kPa. As the viscosity of the reactant increased, the speed of the stirring device was reduced to 68 rpm, 52 rpm, and 32 rpm. During the polycondensation reaction, an appropriate amount of catalyst was added for catalysis. The catalyst was a zirconium-based compound (with a Zr atom content of 300 ppm).

Step (4): The polyester was drawn out in strip form from the bottom of the reactor at 200-260° C., immersed in water at 10° C., and pelletized using a pelletizing device to obtain the final pelletized polyester. The melt index of this polyester was about 4.45.

### Comparative Example 2

Step (1): An aliphatic dicarboxylic acid (e.g., 50 parts by weight of succinic acid) and an aliphatic diol (e.g., 49.8 parts by weight of butanediol) were put into a reactor equipped with a stirring device, a nitrogen inlet, a heating device, a temperature detector, and a pressure reducing exhaust port for depressurization and deoxygenation, and the pressure was restored to atmospheric pressure with nitrogen. This step was repeated 3 times to fill the system with nitrogen.

Step (2): Next, the system was heated to 180-220° C. under nitrogen and 68 rpm stirring, and reacted at this temperature for 2 hours for dehydration.

Step (3): The esterified product of step (2) was transferred to a polycondensation kettle and reacted for 600 minutes at a temperature of 200-260° C. and a pressure of less than 0.1 kPa. The speed of the stirring device was reduced to 68 rpm. During the polycondensation reaction, an appropriate amount of catalyst was added for catalysis. The catalyst was a titanium-based compound (with a Ti atom content of 100 ppm). A product with high viscosity could not be obtained within 600 minutes.

Step (4): The polyester was discharged from the bottom of the reactor at 200-260° C. and immersed in water at 10° C. to cool to obtain the sample.

### Comparative Example 3

Step (1): An aliphatic dicarboxylic acid (e.g., 50 parts by weight of succinic acid) and an aliphatic diol (e.g., 49.8 parts by weight of butanediol) were put into a reactor equipped with a stirring device, a nitrogen inlet, a heating device, a temperature detector, and a pressure reducing exhaust port for depressurization and deoxygenation, and the pressure was restored to atmospheric pressure with nitrogen. This step was repeated 3 times to fill the system with nitrogen.

Step (2): Next, the system was heated to 180-220° C. under nitrogen and 68 rpm stirring, and reacted at this temperature for 2 hours for dehydration.

Step (3): The esterified product of step (2) was transferred to a polycondensation kettle and reacted for 600 minutes at a temperature of 200-260° C. and a pressure of less than 0.1 kPa. The speed of the stirring device was reduced to 68 rpm. During the polycondensation reaction, an appropriate amount of catalyst was added for catalysis. The catalyst was a zirconium-based compound (with a Zr atom content of 250 ppm) and a titanium-based compound (with a Ti atom content of 5 ppm). A product with high viscosity could not be obtained within 600 minutes.

Step (4): The polyester was discharged from the bottom of the reactor at 200-260° C. and immersed in water at 10° C. to cool to obtain the sample.

### Result

Embodiments 1-14 and Comparative Examples 1-3 were evaluated to judge the properties of these polyester compositions. As described above, Embodiments 2-14 and Comparative Examples 1-3 were prepared according to a method similar to that of Embodiment 1 described above. However, the prepared polyester compositions were different in terms of the reaction time in the process, the type of C2-12 aliphatic dicarboxylic acid, the content of zirconium atoms, the content of titanium atoms, and the weight ratio of titanium to zirconium.

The melt index, acid value, yellowness index (YI), zirconium atom content, titanium atom content and titanium/zirconium weight ratio of the polyester composition were further evaluated and analyzed. The process conditions and some physical testing data of Embodiments 1-14 and Comparative Examples 1-3 are provided in Table 1.

TABLE 1

| | | Embodiment | | | | | | | | |
|---|---|---|---|---|---|---|---|---|---|---|
| | | 1 | 2 | 3 | 4 | 5 | 6 | 7 | 8 | 9 |
| Process | Alcohol:Acid | 1.05:1~1.8:1 | | | | | | | | |
| condition | Dicarboxylic acid | succinic acid | | | | | | | | |
| | Zr (ppm) | 250 | 225 | 225 | 120 | 120 | 120 | 50 | 100 | 50 |
| | Ti (ppm) | 16.5 | 40 | 70 | 40 | 70 | 25 | 25 | 100 | 100 |
| | Ti/Zr weight ratio | 0.066 | 0.178 | 0.311 | 0.333 | 0.583 | 0.208 | 0.5 | 1 | 2 |
| | Process time (min) | 485 | 330 | 305 | 320 | 300 | 480 | 540 | 305 | 320 |
| | Temperature (° C.) | 200~260 | | | | | | | | |
| Physical | MI | 1.19 | 1.75 | 1.53 | 2.21 | 3.1 | 1.50 | 4.54 | 2.87 | 4.82 |
| testing | AV (meq KOH/g) | 7.95 | 12.84 | 16.04 | 12.3 | 17.76 | 12.27 | 10.29 | 11.35 | 8.69 |
| | YI | 22.73 | 3.78 | 3.49 | 4.58 | 3.99 | 6.19 | 10.07 | 31.48 | 27.27 |
| | Zr (ICP) (ppm) | 247.3 | 228.7 | 193.3 | 123 | 118.2 | 142.6 | 50.9 | 87.2 | 43.0 |
| | Ti (ICP) (ppm) | 17.2 | 46.3 | 59.1 | 45.6 | 62.1 | 24.6 | 25.4 | 98.0 | 91.9 |
| | Ti/Zr weight ratio | 0.0696 | 0.202 | 0.306 | 0.371 | 0.525 | 0.173 | 0.499 | 1.124 | 2.137 |

| | | Embodiment | | | | | Comparative Example | | |
|---|---|---|---|---|---|---|---|---|---|
| | | 10 | 11 | 12 | 13 | 14 | 1 | 2 | 3 |
| Process | Alcohol:Acid | 1.05:1~1.8:1 | | | | | | | |
| condition | Dicarboxylic acid | succinic acid | | | | adipic acid | succinic acid | | |
| | Zr (ppm) | 20 | 10 | 5 | 2 | 100 | 300 | 0 | 250 |
| | Ti (ppm) | 100 | 100 | 125 | 90 | 100 | 0 | 100 | 5 |
| | Ti/Zr weight ratio | 5 | 10 | 25 | 45 | 1 | — | — | 0.02 |
| | Process time (min) | 365 | 470 | 345 | 315 | 475 | 540 | >600 | >600 |
| | Temperature (° C.) | 200~260 | | | | | | | |
| Physical | MI | 3.59 | 4.31 | 4.85 | 4.39 | 14.2 | 4.45 | X | X |
| testing | AV (meq KOH/g) | 6.55 | 8.43 | 6.54 | 6.72 | 10.21 | 20.55 | X | X |
| | YI | 50.75 | 45.85 | 48.41 | 49.94 | 24.25 | 4.61 | X | X |
| | Zr (ICP) (ppm) | 18.2 | 8.8 | 6.1 | 2.82 | 98.7 | 305.4 | — | 252.7 |
| | Ti (ICP) (ppm) | 101.4 | 100.1 | 129.3 | 92.47 | 100.2 | — | 87.2 | 7.21 |
| | Ti/Zr weight ratio | 5.571 | 11.375 | 21.196 | 32.79 | 1.015 | — | — | 0.029 |

In order to evaluate the melt index (MI) of Embodiments 1-14 and Comparative Examples 1-3, a melt index test was performed. The test is described as follows:
1. Instrument and its brand: melt indexer LMI5000.
2. Sample preparation method: The sample is placed in a hot air circulating oven (80±2° C.*4 hrs) to ensure that no water adheres to the sample to be tested.
3. Test standard: According to ISO 1133-1:2011(E).
4. Test conditions: temperature 190±2° C. and total load (including compression rod) 2.16 kg.
5. Test process: Put 4-8 g of the baked sample to he tested into a heating tube at 190° C., add weights after preheating, and start testing, the melt index of the sample to be tested. Take a sample and weigh it after 10 minutes of timing, test each sample twice, and calculate the average value,

The acid value (AV) of Embodiments 1-14 and Comparative Examples 1-3 was evaluated by the acid value test described as follows:
1. Instrument and its brand: METROHM 725 DOSIMAT.
2. Sample preparation method: Take about 0.4-0.6 g of the sample to be tested and place it in a pre-dried 100 c.c. sample bottle, and add 30-50 mL of o-cresol. Place the sample bottle on the heating stirrer, and heat and stir the sample at 110±5° C. until it is completely dissolved (about 30 minutes). Cool the solution to room temperature and prepare for titration.
3. Test conditions: Do potentiometric titration of the sample dissolved in the test solution with 0.03N KOH.
4. Test process: Add 3 mL 0.01N KCl to the test solution and stir for about 1 minute. Confirm the concentration of the titrant, blank value and titration parameters and set them in the instrument. Then immerse the electrode in the test solution and start the instrument to start the titration. Titration results are expressed in meq KOH/g.

The yellowness index (YI) of Embodiments 1-14 and Comparative Examples 1-3 was evaluated by the color test described as follows:
1. Instrument and its brand: NIPPON DENSHOKU 300a and ZE-2000.
2. Sample preparation method: Take about 20-40 g of powder/particles of the sample to be tested and put it into the quartz cell or use a suitable color plate that has been prepared.
3. Test process: Use EZMQC analysis software to calibrate the white plate and standard color plate, place the sample at the test port of the reflected light test area and fix it, and then perform the test and repeat three times. After the test is completed, average and record the readings (L*, a*, b*, YI) in the window.

For the titanium and zirconium contents of Embodiments 1-14 and Comparative Examples 1-3, the atom content analysis of titanium and zirconium was performed, and the description is as follows:
1. Instrument and its brand: inductively coupled plasma atomic emission spectrometer (ICP-AES) CEM-MARS 6.
2. Sample preparation method: Weigh 0.2 g of the biodegradable composition, add 9 mL of nitric acid/3 mL of hydrochloric acid, and seal it in a microwave digestion vessel. Heat the solution from room temperature to 210° C. within 30 minutes, and then keep it at this temperature for microwave digestion for 30 minutes. Next, cool the solution to 60° C. and add ultrapure water to dilute it to 30 mL, and filter with a filter paper with a pore size of 11 μm and a thickness of 0.18 mm.
3. Test process: Prepare standard solutions for the detection of zirconium and titanium elements and establish an element calibration line, and use ICP-AES to test the sample to be tested after microwave digestion.

The results show that the weight ratio of titanium/zirconium of Embodiments 1-14 is greater than 0.05, the process time of Embodiments 1-14 is shorter than 600 minutes, and the acid value is lower than 20 meq KOH/g. This means that no matter how the diacid type, titanium content and zirconium content change, the desired effect can be achieved as long as the weight ratio of titanium to zirconium in the polyester composition is greater than 0.05.

In contrast, Comparative Example 1 contains only zirconium but not titanium; although the process time is shorter than 600 minutes, the acid value is as high as 20.55 meq Comparative Example 2 contains only titanium but not zirconium, and its process time exceeds 600 minutes, and the desired product with high viscosity cannot be obtained. Although Comparative Example 3 contains titanium and zirconium, the weight ratio of titanium/zirconium is not greater than 0.05, and the process time exceeds 600 minutes, and a product with the target viscosity cannot be obtained.

In addition, the polyester compositions of Embodiments 1-14 also have desired viscosity (melt index 1-30) and excellent yellowness index (less than 55).

In summary, although not limited by any particular theory, the inventor believes that as long as the pre-polycondensation reaction is controlled so that the titanium/zirconium weight ratio of the catalyst is within the desired range and/or the titanium/zirconium weight ratio in the resulting polyester composition is within the desired range, the process time can be reduced (e.g., <600 minutes), and the obtained polyester composition not only is a biodegradable composition, but also has a lower acid value and/or expected viscosity and/or lower yellowness index.

As used herein, all ranges provided are meant to include every specific range within, and combination of sub ranges between, the given ranges. Additionally, all ranges provided herein are inclusive of the end points of such ranges, unless stated otherwise. Thus, a range from 1 to 5, includes specifically 1, 2, 3, 4, and 5, as well as sub ranges such as 2-5, 3-5, 2-3, 2-4, and 1-4.

All publications and patent applications cited in this specification are herein incorporated by reference, and for any and all purposes, as if each individual publication or patent application was specifically and individually indicated to be incorporated by reference. In the event of an inconsistency between the present disclosure and any publication or patent application incorporated herein by reference, the present disclosure controls.

As used herein, the terms “comprising,” “having,” and “including” are used in their open and non-limiting sense. The terms “a,” “an,” and “the” are understood to encompass the plural as well as the singular. The expression “one or more” means “at least one” and thus may include an individual characteristic or mixtures/combinations.

Other than in the operating examples, or where otherwise indicated, all numbers expressing quantities of ingredients and/or reaction conditions may be modified in all instances by the term “about,” meaning within ±5% of the indicated number. The term “substantially free” or “essentially free” as used herein means that there is less than about 2% of the specific characteristic. All elements or characteristics positively set forth in this disclosure can he negatively excluded from the claims.

What is claimed is:

1. A polyester composition comprising aliphatic polyester, titanium and zirconium, wherein the weight ratio of titanium/zirconium is greater than 0.05.

2. The polyester composition of claim 1, wherein the aliphatic polyester is formed by esterification polymerization of C2-12 aliphatic dicarboxylic acid and C2-12 aliphatic diol.

3. The polyester composition of claim 2, wherein the C2-12 aliphatic dicarboxylic acid is selected from a group consisting of malonic acid, oxalic acid, succinic acid, glutaric acid, 2-methylglutaric acid, 3-methylglutaric acid, adipic acid, pimelic acid, suberic acid, azelaic acid, sebacic acid, undecanedioic acid, dodecanedioic acid, brassylic acid, tetradecanedioic acid, 3,3-dimethylglutaric acid, fumaric acid, 2,2-dimethylglutaric acid, fatty acid dimer, 1,3-cyclopentane dicarboxylic acid, 1,4-cyclohexane dicarboxylic acid, 1,3-cyclohexane dicarboxylic acid, diglycolic acid, itaconic acid and maleic acid.

4. The polyester composition of claim 2, wherein the C2-12 aliphatic diol is selected from a group consisting of ethylene glycol, 1,2-propanediol, 1,3-propanediol, 1,2-butanediol, 1,4-butanediol, 1,5-pentanediol, 1,6-hexanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, cyclopentanediol, 1,4-cyclohexanediol, 1,2-cyclohexanedimethanol, 1,3-cyclohexanedimethanol, 1,4-cyclohexanedimethanol and 2,2,4,4-tetramethyl-1,3-cyclobutanediol.

5. The polyester composition of claim 1, wherein the content of the titanium is 15-130 ppm.

6. The polyester composition of claim 1, wherein the titanium is derived from a titanium-based compound, and the titanium-based compound is Ti(OR)₄, where R is a C1-C6 alkyl group.

7. The polyester composition of claim 1, wherein the content of the zirconium is 2-250 ppm.

8. The polyester composition of claim 1, wherein the zirconium is derived from a zirconium-based compound, and the zirconium-based compound is selected from a group consisting of zirconium oxide, zirconium hydroxide, zirconium octoate, zirconium carbonate, alkaline earth zirconate, rare earth zirconate and zircon.

9. The polyester composition of claim 1, which is a biodegradable composition.

10. The polyester composition of claim 1, which has an acid value of less than 20 meq KOH/g.

11. The polyester composition of claim 10. which has a yellowness index (YI) of less than 55.

12. The polyester composition of claim 10, which has a yellowness index of less than 30.

13. The polyester composition of claim 10, which has a melt index (MI) of 1-30.

14. The polyester composition of claim 10, which has a melt index (MI) of 1-15.

15. A preparation method of a polyester composition comprising:
(1) subjecting a C2-12 aliphatic dicarboxylic acid and a C2-12 aliphatic diol to an esterification reaction; and
(2) using a zirconium-based compound and a titanium-based compound as a catalyst to perform a pre-polycondensation reaction to obtain the polyester composition; wherein the weight ratio of titanium/zirconium in the catalyst is greater than 0.05.

16. The preparation method of claim 15, wherein the C2-12 aliphatic dicarboxylic acid is selected from a group consisting of malonic acid, oxalic acid, succinic acid, glutaric acid, 2-methylglutaric acid, 3-methylglutaric acid, adipic acid, pimelic acid, suberic acid, azelaic acid, sebacic acid, undecanedioic acid, dodecanedioic acid, brassylic acid, tetradecanedioic acid; 3,3-dimethylglutaric acid, fumaric acid, 2,2-dimethylglutaric acid, fatly acid dimer, 1,3-cyclopentane dicarboxylic acid, 1,4-cyclohexane dicarboxylic acid, 1,3-cyclohexane dicarboxylic acid, diglycolic acid, itaconic acid and maleic acid.

17. The preparation method of claim 15, wherein the C2-12 aliphatic diol is selected from a group consisting of ethylene glycol, 1,2-propanediol, 1,3-propanediol, 1,2-butanediol, 1,4-butanediol, 1,5-pentanediol, 1,6-hexanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-triethyl-1,6-hexanediol, cyclopentanediol, 1,4-cyclohexanediol, 1,2-cyclohexanedimethanol, 1,3-cyclohexanedimethanol, 1,4-cyclohexanedimethanol and 2,2,4,4-tetramethyl-1,3-cyclobutanediol.

18. The preparation method of claim 15, wherein the titanium-based compound is Ti(OR)₄, where R is a C1-C6 alkyl group.

19. The preparation method of claim 15, wherein the zirconium-based compound is selected from a group consisting of zirconium oxide, zirconium hydroxide, zirconium octoate, zirconium carbonate, alkaline earth zirconate, rare earth zirconate and zircon.

20. A product comprising the polyester composition of claim 1.

21. An application of a polyester composition, which applies the product of claim 20 to the packaging field, the disposable device field, the agricultural field and/or the medical field.
